(19) United States
(12) Patent Application Publication
(10) Pub. No.: US 2024/0144235 A1
(43) Pub. Date: May 2, 2024

(54) TRANSACTION CARD WITH CONVERTIBLE PAYMENT CARD TYPE

(71) Applicant: ANICA CORPORATION, New Taipei City (TW)

(72) Inventor: MENG-JEN CHENG, New Taipei City (TW)

(21) Appl. No.: 17/973,566

(22) Filed: Oct. 26, 2022

(51) Int. Cl. G06Q 20/34; G06Q 20/32; G06Q 20/40

(52) U.S. Cl. CPC G06Q 20/341; G06Q 20/3226; G06Q 20/40145

(57) ABSTRACT

A transaction card with a convertible payment card type includes a mobile communication device and a transaction card. The mobile communication device includes a setting unit, a transaction card storage unit and a verification unit; the transaction card includes a processing unit, a link unit, a verification storage unit and a transaction card data register unit; the transaction card links the mobile communication device, and one transaction card data of multiple transaction card data in the mobile communication device is temporarily stored in the transaction card. The present disclosure selects a different payment card type in the mobile communication device by itself and temporarily store the selected card type in the transaction card to replace the original card type temporarily stored in the transaction card for transactions according to the offer provided by the merchant after verification to achieve the purpose of improving the convenience and security of use.

### BACKGROUND OF THE INVENTION

### 1. Field of the Invention

The present disclosure provides a transaction card with a convertible payment card type, and in particular to a transaction card with a convertible payment card type that can select a different payment card type to replace the original card type for transactions.

### 2. Description of the Related Art

At present, most consumers will use credit cards, easy cards and other plastic money for transactions; however, because of the different card issuing banks cooperated by each merchant, the credit cards with different card type have different offers.

In order to enjoy the preferable offers, consumers are usually required to carry all physical credit cards to select different card type for transactions according to different offers, but because of carrying multiple credit cards, there are situations occurred that they are not easy to deposit, carried with the wrong card type and easy to lose.

Thus, it is desirable to create a transaction card with a convertible payment card type, so that it can select a different payment card type and temporarily store the selected card type in the transaction card to replace the original card type temporarily stored in the transaction card for transactions according to the offer provided by the merchant to achieve the purpose of improving the convenience and security of use, thereby effectively improving the shortcoming of prior art that are to be actively disclosed by the disclosure.

### BRIEF SUMMARY OF THE INVENTION

In view of the shortcomings of the above-mentioned prior art, the inventor felt that it was not perfect, and exhausted his mind to research carefully into a way for overcoming the problems, and then developed a transaction card with a convertible payment card type, with a view to achieving the purpose of improving the convenience and security of use by selecting a different payment card type and temporarily storing the selected card type in the transaction card to replace the original card type temporarily stored in the transaction card for transactions according to the offer provided by the merchant.

To achieve the above objective and other objectives, the present disclosure provides a transaction card with a convertible payment card type, which comprises a mobile communication device and a transaction card. The mobile communication device at least includes a setting unit, a transaction card storage unit and a verification unit that are interconnected, the setting unit at least sets a verification code, transaction card data and cardholder personal data of a cardholder, the transaction card storage unit at least stores the verification code, the multiple transaction card data and the cardholder personal data, the verification unit at least carries out verification according to the verification code; the transaction card links the mobile communication device, the transaction card at least comprises a processing unit, a link unit, a verification storage unit and a transaction card data register unit that are interconnected, the processing unit is at least for the operation processing of the link unit, the verification storage unit and the transaction card data register unit, the link unit is linked to the mobile communication device and powered to the processing unit, the verification storage unit provides a verification code to the transaction card storage unit of the mobile communication device, and verified by the verification unit, the transaction card data register unit stores one of the transaction card data in the transaction card storage unit.

In the above-mentioned transaction card with a convertible payment card type, the mobile communication device is a smart phone, the setting unit, the transaction card storage unit and the verification unit are applications (APP) and stored in a memory of the smart phone, and executed and actuated by a processor of the smart phone.

In the above-mentioned transaction card with a convertible payment card type, the mobile communication device is a smart phone, the setting unit, the transaction card storage unit and the verification unit are external devices, and are connected to a processor of the smart phone in a wired or wireless manner.

In the above-mentioned transaction card with a convertible payment card type, the transaction card storage unit is provided with a verification code storage module, a transaction card data storage module and a cardholder personal data storage module, the verification code storage module stores the verification code, the transaction card data storage module stores the multiple transaction card data, the cardholder personal data storage module stores the cardholder personal data.

In the above-mentioned transaction card with a convertible payment card type, the link unit and the mobile communication device carry out wireless linking by radio frequency antenna, near field communication (NFC), or Bluetooth protocol.

In the above-mentioned transaction card with a convertible payment card type, the verification storage unit is a persistent memory, the transaction card data register unit is a flash memory.

In the above-mentioned transaction card with a convertible payment card type, the processing unit is a central processing unit, an integrated circuit chip or a logic circuit.

In the above-mentioned transaction card with a convertible payment card type, the transaction card further comprises a display unit, electrically connected to the processing unit, the display unit is used as a prompt when transacting, and the display unit is a screen, a light emitter, or a combination thereof.

In the above-mentioned transaction card with a convertible payment card type, the transaction card further comprises a power storage unit, electrically connected to the processing unit, the power storage unit receives and stores power of the link unit, in order to supply power to the processing unit, the verification storage unit and the transaction card data register unit.

In the above-mentioned transaction card with a convertible payment card type, the transaction card further comprises a fingerprint receiving unit, electrically connected to the processing unit, the verification storage unit further stores cardholder fingerprint data, after the fingerprint receiving unit receives a fingerprint, and the fingerprint is verified with the cardholder fingerprint data in the verification storage unit.

Accordingly, as to the transaction card with a convertible payment card type of the present disclosure, it can select a different payment card type in the mobile communication device by itself and temporarily store the selected card type in the transaction card to replace the original card type temporarily stored in the transaction card for transactions according to the offer provided by the merchant after verification to achieve the purpose of improving the convenience and security of use.

### BRIEF DESCRIPTION OF THE DRAWINGS

FIG. 1 is a schematic outside view of a first embodiment of the present disclosure.

FIG. 2 is a schematic block diagram of the first embodiment of the present disclosure.

FIG. 3 is a schematic outside view of a second embodiment of the present disclosure.

FIG. 4 is a schematic block diagram of the second embodiment of the present disclosure.

### DETAILED DESCRIPTION OF THE INVENTION

To facilitate understanding of the above purpose, characteristics and effects of this present disclosure, embodiments together with the attached drawings for the detailed description of the present disclosure are provided as below.

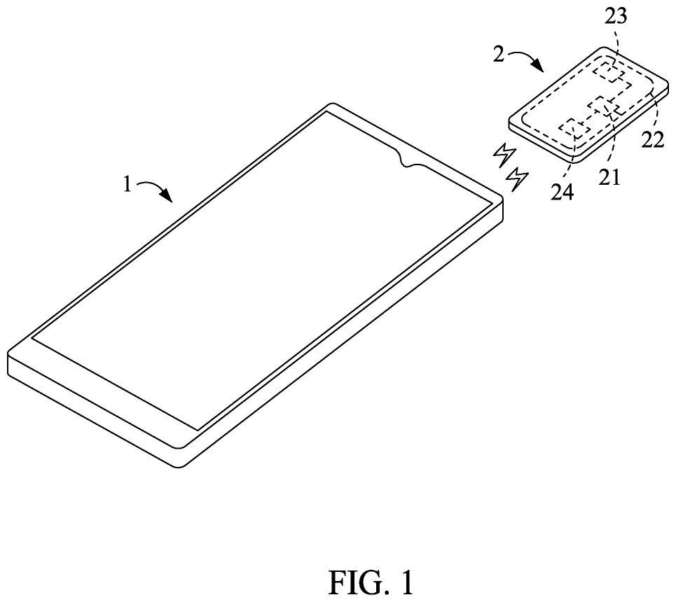

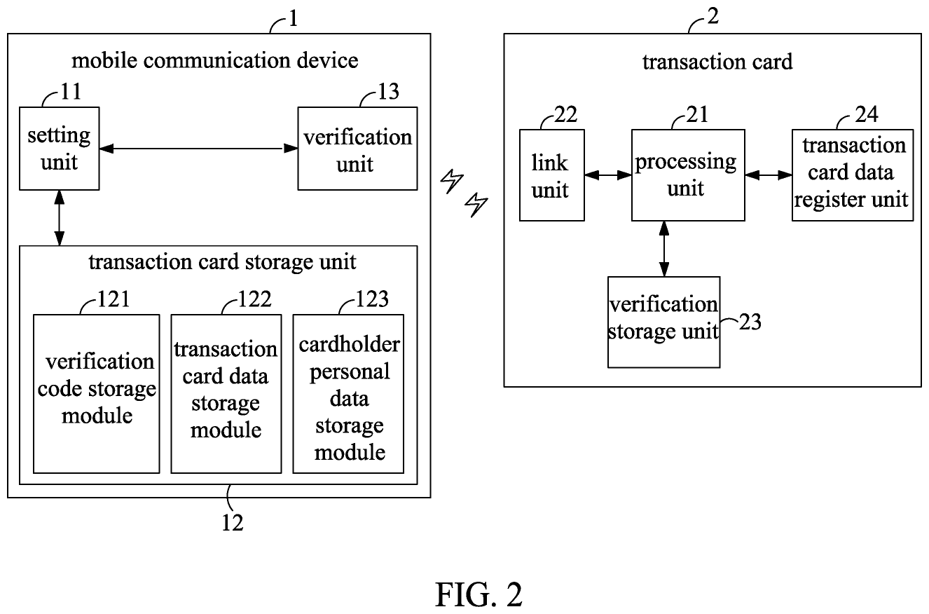

Referring to FIGS. 1 to 2, as shown in the drawings, the present disclosure is a transaction card with a convertible payment card type, which comprises a mobile communication device 1 and a transaction card 2.

The mobile communication device 1 at least includes a setting unit 11, a transaction card storage unit 12 and a verification unit 13 that are interconnected, the setting unit 11 at least sets a verification code, transaction card data and cardholder personal data of a cardholder, the transaction card storage unit 12 at least stores the verification code, multiple transaction card data and cardholder personal data, the verification unit 13 at least carries out verification according to the verification code.

The transaction card 2 links the mobile communication device 1, the transaction card 2 at least comprises a processing unit 21, a link unit 22, a verification storage unit 23 and a transaction card data register unit 24 that are interconnected, the processing unit 21 is at least for the operation processing of the link unit 22, the verification storage unit 23 and the transaction card data register unit 24, the processing unit 21 may be a central processing unit, an integrated circuit chip or a logic circuit, whereby the processing unit 21 is for the operation processing at transacting, and is at least for the operation processing of the link unit 22, the verification storage unit 23 and the transaction card data register unit 24 at operating, the link unit 22 is linked to the mobile communication device 1 and powered to the processing unit 21, the verification storage unit 23 provides a verification code to the transaction card storage unit 12 of the mobile communication device 1, and verified by the verification unit 13, the transaction card data register unit 24 stores one of the transaction card data in the transaction card storage unit 12.

When the present disclosure is used, the link unit 22 may be enabled to read electromagnetic waves from the mobile communication device 1, in order to induce and generate the required power to provide to the processing unit 21, the link unit 22, the verification storage unit 23 and the transaction card data register unit 24, and then the relevant settings between the mobile communication device 1 and the transaction card 2 are carried out, for example, the setting is carried out by the setting unit 11 according to the cardholder personal data, payment information, transaction data, different transaction card type data etc., and the verification code generated by the mobile communication device 1 is stored in the verification storage unit 23 of the transaction card 2, or the verification code is transmitted and stored to the transaction card storage unit 12 of the mobile communication device 1 by the verification storage unit 23 of the transaction card 2, so that the transaction card storage unit 12 of the mobile communication device 1 and the verification storage unit 23 of the transaction card 2 simultaneously has the same verification code, and then the mobile communication device 1 and the transaction card 2 are paired with the verification code, so as to bind the mobile communication device 1 to the transaction card 2, and thus the mobile communication device 1 can only communicate with the transaction card 2 for data transmission.

When the present disclosure is carrying out transaction, the cardholder may select the required transaction card data in the transaction card storage unit 12 of the mobile communication device 1 according to the offer provided by the merchant, and then use the transaction card 2 to be close to the mobile communication device 1 to carry out a link, so that the link unit 22 of the transaction card 2 reads the electromagnetic waves from the mobile communication device 1 to induce and generate the required power, thereby starting the processing unit 21 after obtaining external power, the processing unit 21 transmits the verification code in the verification storage unit 23 to the verification unit 13 of the mobile communication device 1, whereby the verification unit 13 carries out decoding and authentication according to the verification code originally set in the transaction card storage unit 12, and after the authentication, the transaction card data currently selected in the mobile communication device 1 is encoded and transmitted to the transaction card data register unit 24 of the transaction card 2, thereby replacing the transaction card type originally temporarily stored in the transaction card data register unit 24 by the transaction card data currently selected in the mobile communication device 1, the transaction card 2 transacts by the currently selected transaction card type to convert the card type to be paid, thereby enhancing the convenience and security of use.

As described above, when the present disclosure is used in practice, the cardholder does not need to carry multiple transaction cards, only one mobile communication device 1 and one transaction card 2 are needed to be carried, since the transaction card storage unit 12 of the mobile communication device 1 has been set and stored in advance with multiple transaction card data issued by different banks or the same bank; when different transaction cards are selected according to the offer provided by the merchant, the transaction card type is first selected in the mobile communication device 1, the transaction card data selected in the mobile communication device 1 is stored to the transaction card 2, so that the transaction card 2 is converted into the transaction card type selected in the mobile communication device 1, and then the transaction card 2 after converting card type transacts directly. Accordingly, the cardholder can select a different payment card type in the mobile communication device 1, and temporarily store the selected card type in the transaction card 2 to replace the card type temporarily stored in the original transaction card 2 for transactions, thereby achieving the purpose of improving the convenience and security of use.

In addition to the above embodiments, in one embodiment of the present disclosure, the mobile communication device 1 is a smart phone, the setting unit 11, the transaction card storage unit 12 and the verification unit 13 are applications (APP) and stored in a memory of the smart phone, and executed and actuated by a processor of the smart phone. Further, the mobile communication device is a smart phone, the setting unit 11, the transaction card storage unit 12 and the verification unit 13 are external devices, and are connected to a processor of the smart phone in a wired or wireless manner (not shown). Thus, according to different use needs, the units 11, 12, 13 can go with the mobile communication device 1 in a built-in or plug-in manner for use, so that the present disclosure can further meet the needs of practical application.

In addition to the above embodiments, in one embodiment of the present disclosure, the transaction card storage unit 12 is provided with a verification code storage module 121, a transaction card data storage module 122 and a cardholder personal data storage module 123, the verification code storage module 121 stores the verification code, the transaction card data storage module 122 stores the multiple transaction card data, the cardholder personal data storage module 123 stores the cardholder personal data. Accordingly, the verification code, the multiple transaction card data and the cardholder personal data can be stored separately, which not only is easy to carry out data collection, but also avoids occurring information security problems.

In addition to the above embodiments, in one embodiment of the present disclosure, the link unit 22 and the mobile communication device 1 may carry out wireless linking by radio frequency antenna, near field communication (NFC), or Bluetooth protocol. Thus, the linking may be carried out according to different use needs or methods, and the stability is maintained when the link unit 22 is connected to the mobile communication device 1.

In addition to the above embodiments, in one embodiment of the present disclosure, the verification storage unit 23 is a persistent memory, so that the verification storage unit 23 is not susceptible to tampering, thereby protecting information security. Further, the transaction card data register unit 24 is a flash memory, in order to achieve the convenience of use.

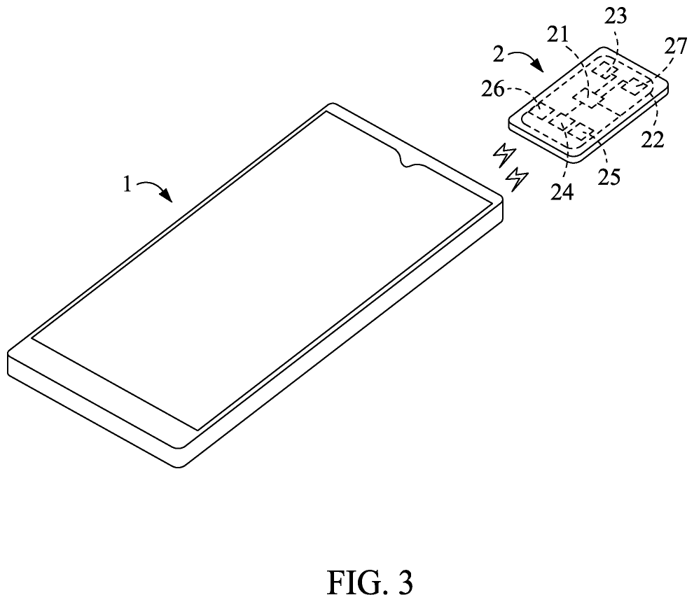

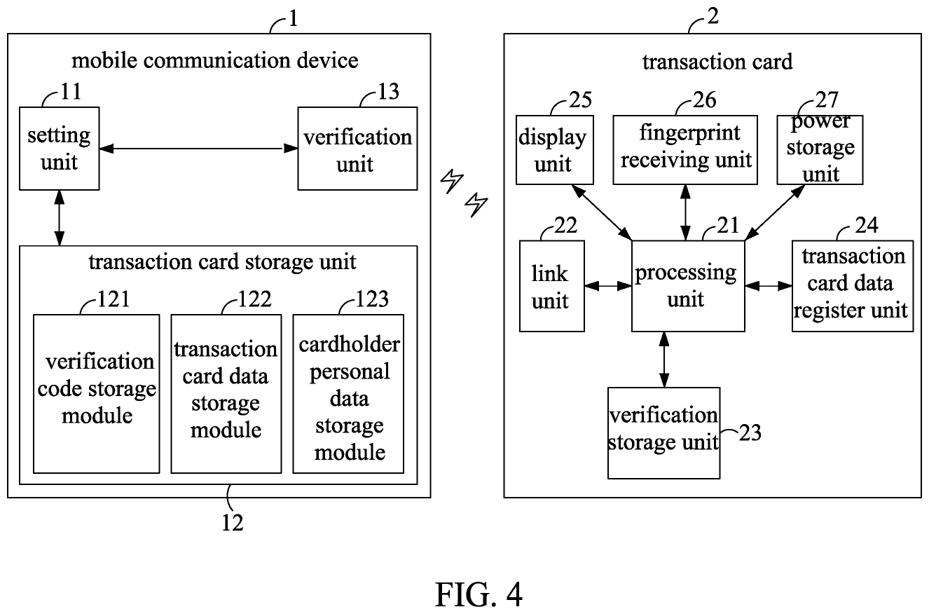

Referring to FIGS. 3 and 4, as shown in the drawings: in addition to the above embodiments, in one embodiment of the present disclosure, the transaction card further comprises a display unit 25, which is electrically connected to the processing unit 21, the display unit 25 may be used as a prompt when transacting, and the display unit 25 may be a screen, a light emitter, or a combination thereof.

Based on the above embodiments, when the transaction card 2 is set, the link unit 22 may read electromagnetic waves from the mobile communication device 1 for power supply, and at the same time the processing unit 21 drives the display unit 25 to output a confirmation message or output a transaction message (e.g., text message, numeral message, lamp signal message or a combination thereof), in order to increase the prompt effect to inform the cardholder of the relevant consumption information, thereby enhancing the security and convenience of use.

Also, when the present disclosure is carrying out transaction, the cardholder may use the transaction card 2 to be close to a payment device (not shown), so that the link unit 22 reads the electromagnetic waves from the payment device to induce and generate the required power, thereby starting the processing unit 21 for transactions after obtaining external power, and the processing unit 21 drives the display unit 25 to output a confirmation message to inform the cardholder that the transaction is being processed or has been processed. Accordingly, the transaction card 2 may be connected to the payment device to obtain power, and the display unit outputs the transaction message, thereby enhancing the security and convenience of use.

Whereas, when the transaction ends to remove the transaction card 2, the link unit 22 is unable to read the electromagnetic waves from the payment device and generate a power outage, so that the power is no longer provided to the processing unit 21, and then the processing unit 21 presents an off state, so that the display unit no longer outputs any transaction message to prompt the cardholder that the transaction ends and the card is in an unused state.

In addition to the above embodiments, in one embodiment of the present disclosure, the transaction card further comprises a fingerprint receiving unit 26, which is electrically connected to the processing unit 21, the verification storage unit 23 further stores cardholder fingerprint data, after the fingerprint receiving unit 26 receives a fingerprint, and the fingerprint is verified with the cardholder fingerprint data in the verification storage unit 23, and the above setting of the transaction card 2 is executed after verification and confirmation, or the transaction is carried out after the transaction card is set, and it is set that the transaction message can be output by the display unit 25 at the time of transacting, thereby enhancing the security and convenience of use.

In addition to the above embodiments, in one embodiment of the present disclosure, the transaction card further comprises a power storage unit 27, which is electrically connected to the processing unit 21, the power storage unit 27 receives and stores power of the link unit 22, thereby acting as a backup power, when the link unit 22 fails to obtain power, it can supply power for use, in order to supply power to the processing unit 21, the verification storage unit 23, the transaction card data register unit 24, the display unit 25 and the fingerprint receiving unit 26, thereby maintaining the stability of the transaction card 2 when used.

While the present disclosure has been described by means of preferable embodiments, those skilled in the art should understand the above description is merely embodiments of the disclosure, and it should not be considered to limit the scope of the disclosure. It should be noted that all changes and substitutions which come within the meaning and range of equivalency of the embodiments are intended to be embraced in the scope of the disclosure. Therefore, the scope of the disclosure is defined by the claims.

What is claimed is:

1. A transaction card with a convertible payment card type, comprising:
a mobile communication device, at least including a setting unit, a transaction card storage unit and a verification unit that are interconnected, the setting unit at least sets a verification code, transaction card data and cardholder personal data, the transaction card storage unit at least stores the verification code, the multiple transaction card data and the cardholder personal data, the verification unit at least carries out verification according to the verification code; and
a transaction card, linking the mobile communication device, the transaction card at least comprises a processing unit, a link unit, a verification storage unit and a transaction card data register unit that are interconnected, the processing unit is at least for the operation processing of the link unit, the verification storage unit and the transaction card data register unit, the link unit is linked to the mobile communication device and powered to the processing unit, the verification storage unit provides a verification code to the transaction card storage unit of the mobile communication device, and verified by the verification unit, the transaction card data register unit stores one of the transaction card data in the transaction card storage unit.

2. The transaction card with a convertible payment card type according to claim 1, wherein the mobile communication device is a smart phone, the setting unit, the transaction card storage unit and the verification unit are applications (APP) and stored in a memory of the smart phone, and executed by a processor of the smart phone.

3. The transaction card with a convertible payment card type according to claim 1, wherein the mobile communication device is a smart phone, the setting unit, the transaction card storage unit and the verification unit are external devices, and are connected to a processor of the smart phone in a wired or wireless manner.

4. The transaction card with a convertible payment card type according to claim 1, wherein the transaction card storage unit is provided with a verification code storage module, a transaction card data storage module and a cardholder personal data storage module, the verification code storage module stores the verification code, the transaction card data storage module stores the multiple transaction card data, the cardholder personal data storage module stores the cardholder personal data.

5. The transaction card with a convertible payment card type according to claim 1, wherein the link unit and the mobile communication device carry out wireless linking by radio frequency antenna, near field communication (NFC), or Bluetooth protocol.

6. The transaction card with a convertible payment card type according to claim 1, wherein the verification storage unit is a persistent memory, the transaction card data register unit is a flash memory.

7. The transaction card with a convertible payment card type according to claim 1, wherein the processing unit is a central processing unit, an integrated circuit chip or a logic circuit.

8. The transaction card with a convertible payment card type according to claim 1, wherein the transaction card further comprises a display unit, electrically connected to the processing unit, the display unit is used as a prompt when transacting, and the display unit is a screen, a light emitter, or a combination thereof.

9. The transaction card with a convertible payment card type according to claim 1, wherein the transaction card further comprises a power storage unit, electrically connected to the processing unit, the power storage unit receives and stores the power of the link unit, in order to supply power to the processing unit, the verification storage unit and the transaction card data register unit.

10. The transaction card with a convertible payment card type according to claim 1, wherein the transaction card further comprises a fingerprint receiving unit, electrically connected to the processing unit, the verification storage unit further stores cardholder fingerprint data, after the fingerprint receiving unit receives a fingerprint, and the fingerprint is verified with the cardholder fingerprint data in the verification storage unit.
